(19) United States
(12) Patent Application Publication
(10) Pub. No.: US 2018/0199510 A1
(43) Pub. Date: Jul. 19, 2018

(54) STALK ROLL SHAFT RETENTION ASSEMBLY

(71) Applicant: 360 Yield Center, Morton, IL (US)

(72) Inventor: Austin Ehle, Mount Pulaski, IL (US)

(21) Appl. No.: 15/873,583

(22) Filed: Jan. 17, 2018

Related U.S. Application Data
(60) Provisional application No. 62/447,236, filed on Jan. 17, 2017.

(51) Int. Cl. A01D 45/02; A01D 41/06; A01D 57/22

(52) U.S. Cl. CPC A01D 45/025; A01D 91/04; A01D 57/22; A01D 41/06

(57) ABSTRACT

A combine head and stalk roll retention shaft apparatus. The combine head may include a plurality of combine head row units. A drive system is provided to drive the row units and a stalk roll feeder; the feeder having a drive system to drive the feeder and feed corn stalks into at least one of the plurality of combine head row units. The stalk roll retention apparatus may be slidably attached proximate to the tip of the stalk roller shaft to reduce wear of the stalk rollers and guide the corn stalks into the row unit(s). The stalk roll retention shaft apparatus may include one more bearings. The stalk roll retention shaft apparatus may also include a cap or plug on the front of the apparatus.

### CROSS-REFERENCE TO RELATED APPLICATIONS

This application claims priority to provisional application U.S. Ser. No. 62/447,236 filed Jan. 17, 2017, which is incorporated herein by reference in its entirety.

### FIELD OF THE INVENTION

The invention relates generally to agricultural implements. More specifically, but not exclusively, the invention relates to a row unit of a corn head. Even more specifically, but not exclusively, the invention relates to a shaft retention assembly for the stalk roller(s) of a corn head row unit.

### BACKGROUND OF THE INVENTION

It is well recognized that the performance of a combine, and in particular the combine head, is critical to harvesting each and every bushel of a crop. In order to perform at the required level, virtually all commercially available combine heads are designed to efficiently and effectively capture the seeds of the crop.

For example, a conventional agricultural combine traditionally utilizes a conventional header attachment for harvesting an agricultural product such as corn (i.e., a “corn head” or “cornheader”). The conventional cornheader may include a plurality of conical shaped crop divider points (commonly referred to as “points” or “snouts”) which extend forwardly and diverge rearwardly. Row unit assemblies are disposed between the adjacent points where the rearwardly diverging points nearly converge. A corn head may include twelve row unit assemblies (i.e., a 12-row corn head), but corn head sizes can range from four rows to twenty-four rows or more.

During harvesting operations, the combine is positioned with the points of the corn head positioned between adjacent corn rows and below the ears on the cornstalks. As the combine drives forwardly through the field, the conical, rearwardly diverging shape of the points causes the cornstalks within each row to be guided and directed into the row unit assemblies between the adjacent points. The row unit assemblies may then separate the ears from the cornstalks and convey the separated ears toward the cross-auger. The cross-auger may communicate the separated ears toward the opening of the feederhouse in the middle of the cornheader. The feederhouse conveys the ears into the interior of the combine where the corn kernels are separated from the corncob. The separated kernels then pass over a series of screens which separates unwanted crop material and other residue from the kernels. The clean grain is then carried by elevators to a clean grain holding tank while the corncobs, leaves, husks and cornstalks which entered the combine are chopped and discharged through the rear of the combine and mix with the cornstalks that pass under the combine.

Each row unit may include a pair of gathering chains with outwardly extending lugs. The gathering chains extend around drive sprockets and idler sprockets. Rotation of the drive sprockets causes the gathering chains to rotate in adjacent parallel paths such that as the combine drives forwardly through the field, the outwardly extending lugs draw the cornstalks into the row unit. Below the rotating gathering chains is a pair of spaced stripper plates. The stripper plates are spaced sufficiently apart to define a gap between them which is sufficiently wide to permit the corn stalks to enter but which is sufficiently narrow so that the corn ears cannot pass through. A pair of rapidly rotating stalk rolls are positioned below stripper plates.

During harvesting operations, the rotating stalk rollers rapidly pull the corn stalks downwardly through the gap between the stripper plates such that when the corn ears engage the stripper plates, the ears are pulled or stripped from the cornstalks. Ideally, as the stalk rolls rotate, the entire cornstalk is pulled downwardly through the gap and is returned to the field below the header as the combine drives forwardly. It should be appreciated that if the cornstalk snaps or breaks prior to ear separation or after ear separation such that the entire cornstalk is not pulled through the gap, the amount of plant material entering the feederhouse will increase, requiring more horsepower and thus more fuel consumption. The stripped ears which remain on the stripper plates after the cornstalk is pulled through the gap are then conveyed by the lugs of the gathering chains upwardly and rearwardly to the cross-auger. The cross-auger augers the ears to the feederhouse, and the feederhouse feeds the ears into the interior of the combine for shelling and separating the kernels from the corncob as is known in the art.

However, in current corn head row unit designs, the edge or tip of the stalk rollers remains exposed. This can create inconsistent feeding of the row of corn into the row unit and corn head, as well as increased wear on the nose or tip of the stalk rollers. While retro-fit kits have been developed to protect the nose or tip of the stalk rollers, the prior art requires that the stalk roller protection plate be attached to the nose/tip of the stalk rollers by a bolt or pin. For example, U.S. Pat. No. 9,414,542, which is herein incorporated by reference in its entirety, discloses a stalk roll alignment system. These designs can be cumbersome to install and can inhibit the functionality of the stalk rollers. Therefore, there remains a need in the art for a stalk roller shaft retention apparatus that is easily installed on the row unit of a corn head that aids alignment of the stalk rollers.

### BRIEF SUMMARY OF THE INVENTION

Therefore, it is a primary object, feature, and/or advantage of the invention to improve on and/or overcome the deficiencies in the art.

It is another object, feature, and/or advantage of the invention to provide a row unit for an agricultural corn head, wherein the row unit may include a row unit frame with a pair of frame members and a gearbox coupled to the row unit frame. The gearbox comprises a gearing assembly with at least one rotatable shaft member configured to be operatively attached to a stalk roller. The stalk roller may include a first end and a second end, the second end being operatively attached to the rotatable shaft member. The stalk roller coupler may be removably attached to the first end of the stalk roller. The row unit may also include a stalk roller retention bracket slidably attached to the stalk roller coupler and removably secured to the row unit frame.

It is yet another object, feature, and/or advantage of the invention to provide a row unit including a stalk roller bracket with a cavity. The cavity may include an aperture and a plug configured to be removably secured within the aperture.

It is a further object, feature, and/or advantage of the invention to provide a row unit including a stalk roller retention bracket including a cavity. The one or more bearings may be positioned within the cavity of the stalk roller retention bracket.

It is still a further object, feature, and/or advantage of the invention to provide a stalk roller assembly comprising a stalk roller with a first end and a second end. The stalk roller assembly may also include a stalk roller coupler that is removably attached to the first end of the stalk roller. A stalk roller retention bracket may be slidably attached to the stalk roller coupler. The stalk roller retention bracket may include a cavity configured to slidably receive the stalk roller coupler. The stalk roller assembly may also include one or more bearings positioned within the cavity of the stalk roller retention bracket, and the one or more bearings are configured to operatively engage the stalk roller coupler.

It is still yet a further object, feature, and/or advantage of the invention to provide a stalk roller retention assembly comprising a stalk roller retention bracket including a cavity. The cavity of the stalk roller retention bracket may be configured to slidably receive a stalk roller coupler. The cavity of the stalk roller retention bracket may also include an aperture, and a plug removably inserted within the aperture. The aperture in the retention bracket may include internal threads and the plug may include matching external threads, wherein the internal threads and external threads are configured to mate when the plug is inserted in the aperture.

These and/or other objects, features, and advantages of the invention will be apparent to those skilled in the art. The invention is not to be limited to or by these objects, features and advantages. No single embodiment need provide each and every object, feature, or advantage.

### BRIEF DESCRIPTION OF THE DRAWINGS

FIG. 1A is a perspective view of a row unit of a corn head including a stalk roll retention shaft.

FIG. 1B is an alternate perspective view of the row unit of FIG. 1A.

FIG. 2 is a bottom view of the row unit of FIG. 1A.

FIG. 3 is a front view of the row unit of FIG. 1A.

FIG. 4A is an exploded perspective view of a stalk roll retention shaft.

FIG. 4B is an alternate exploded perspective view of the stalk roll retention shaft of FIG. 4A.

FIG. 4C is an alternate exploded perspective view of the stalk roll retention shaft of FIG. 4A.

FIG. 4D is an alternate exploded perspective view of the stalk roll retention shaft of FIG. 4A.

FIG. 5 is an exploded top view of the stalk roll retention shaft of FIG. 4A.

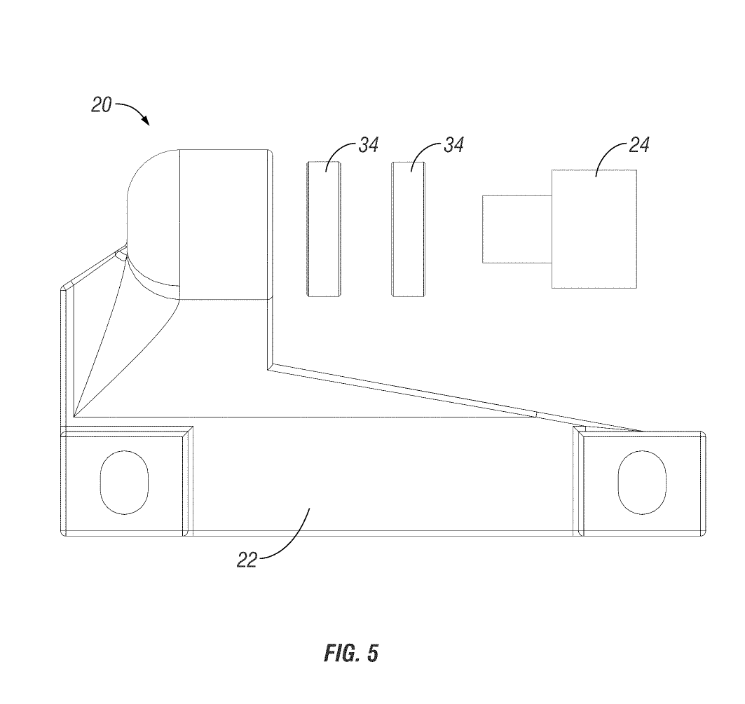

FIG. 6 is an assembled top view of the stalk roll retention shaft of FIG. 4A.

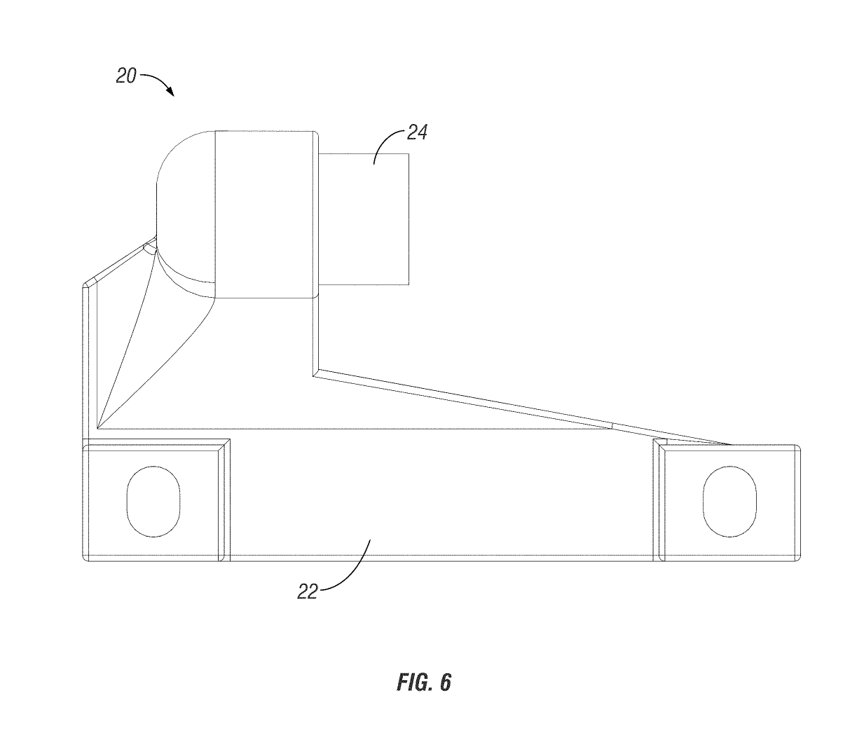

FIG. 7 is an assembled perspective view of the stalk roll retention shaft of FIG. 4A.

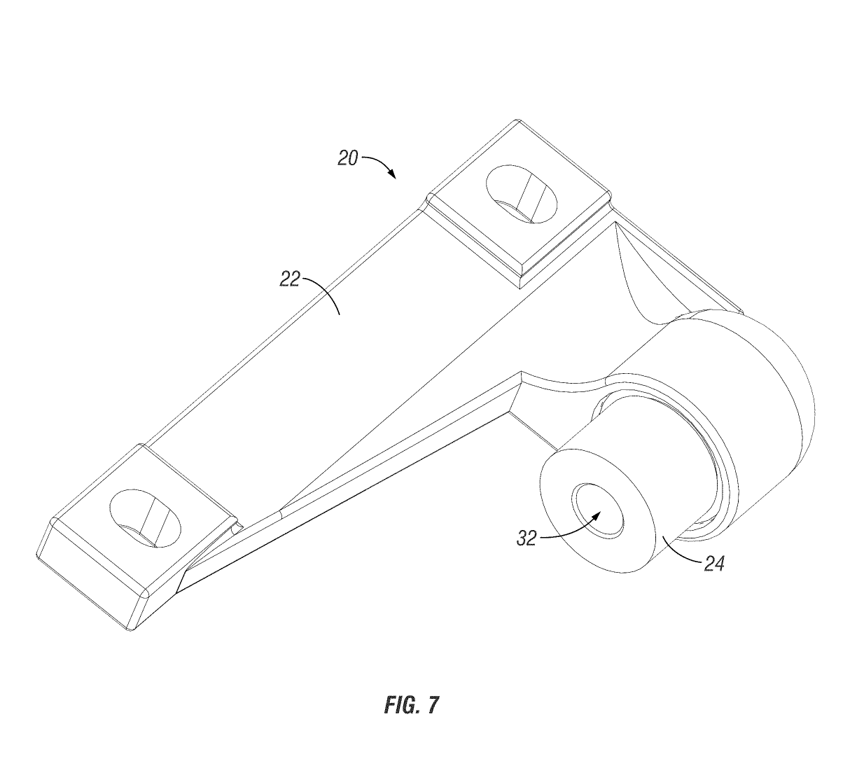

FIG. 8 is an alternate assembled perspective view of the stalk roll retention shaft of FIG. 4A.

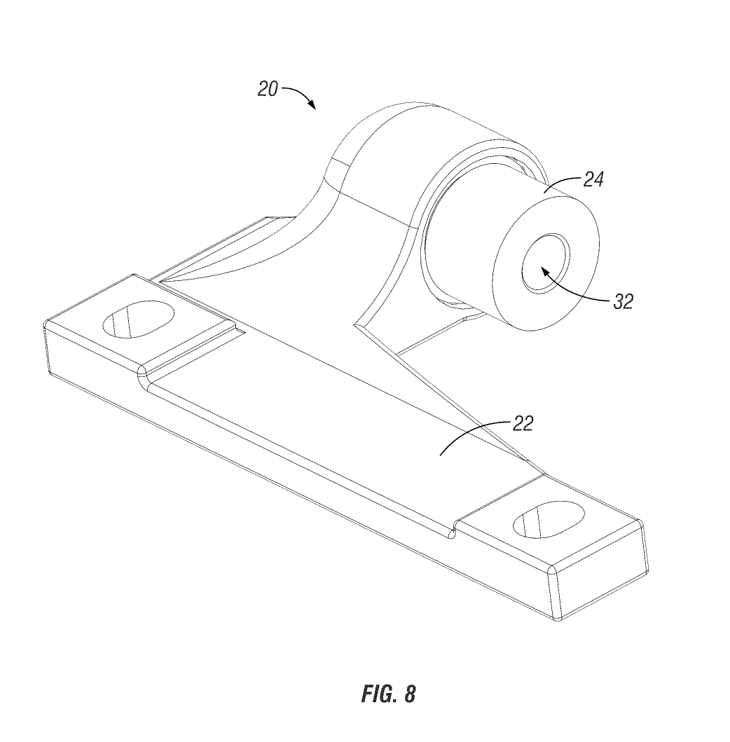

Appendix A is a presentation on the advantages of the present stalk roll retention shaft and additional 3-Dimensional drawings of the present design.

Various embodiments of the invention will be described in detail with reference to the drawings, wherein like reference numerals represent like parts throughout the several views. Reference to various embodiments does not limit the scope of the invention. Figures represented herein are not limitations to the various embodiments according to the invention and are presented for exemplary illustration of the invention.

### DETAILED DESCRIPTION

The invention is directed towards a shaft retention apparatus 20 for the stalk roller(s) 12 of a row unit 10 of an agricultural corn head. The row unit 10 of an agricultural combine head generally includes a frame comprised of two parallel oriented frame members. The row unit 10 may also include a gear box 14 and gearing assembly configured to rotate and operate the other components of the row unit 10. For example, the row unit 10 may include one or more gather chains operatively attached to the frame and configured to feed the stalk between the parallel frame members of the row unit 10 from the front of the row unit 10 toward the rear of the row unit 10. The row unit 10 also generally includes one or more stalk roll shafts 16 extending from the gear box 14. The gear box 14 may be configured to translate rotational movement provided by the combine or tractor and convert it to rotational movement of the stalk roll shaft 16.

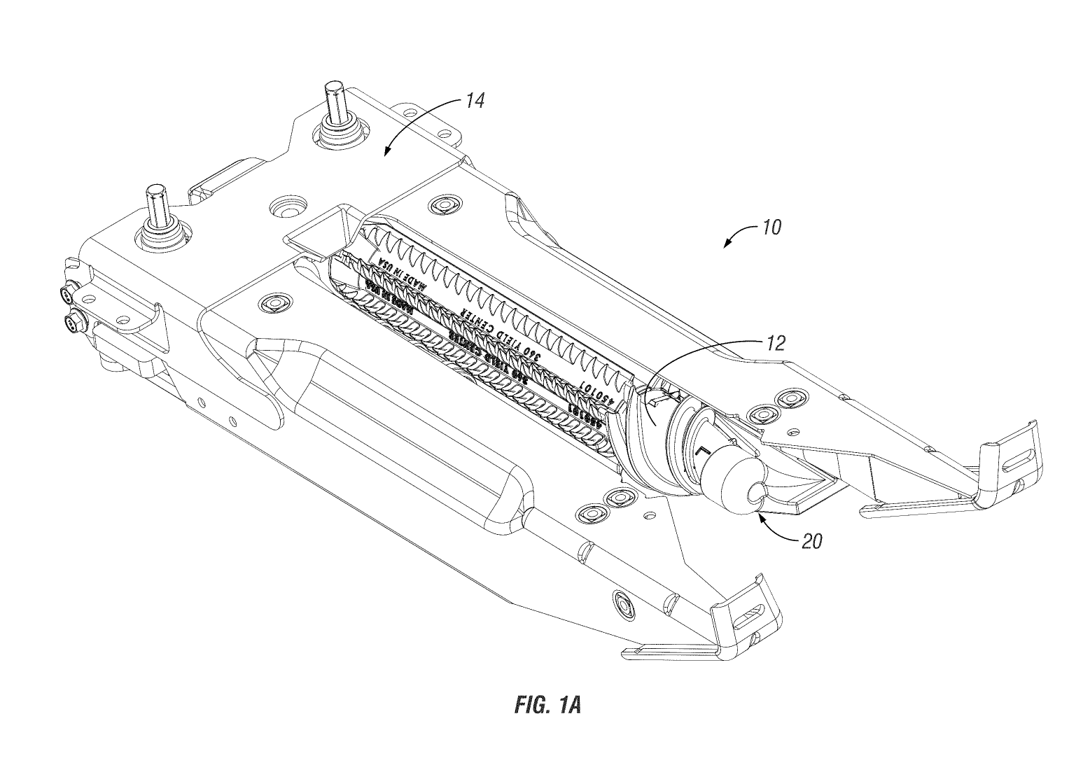

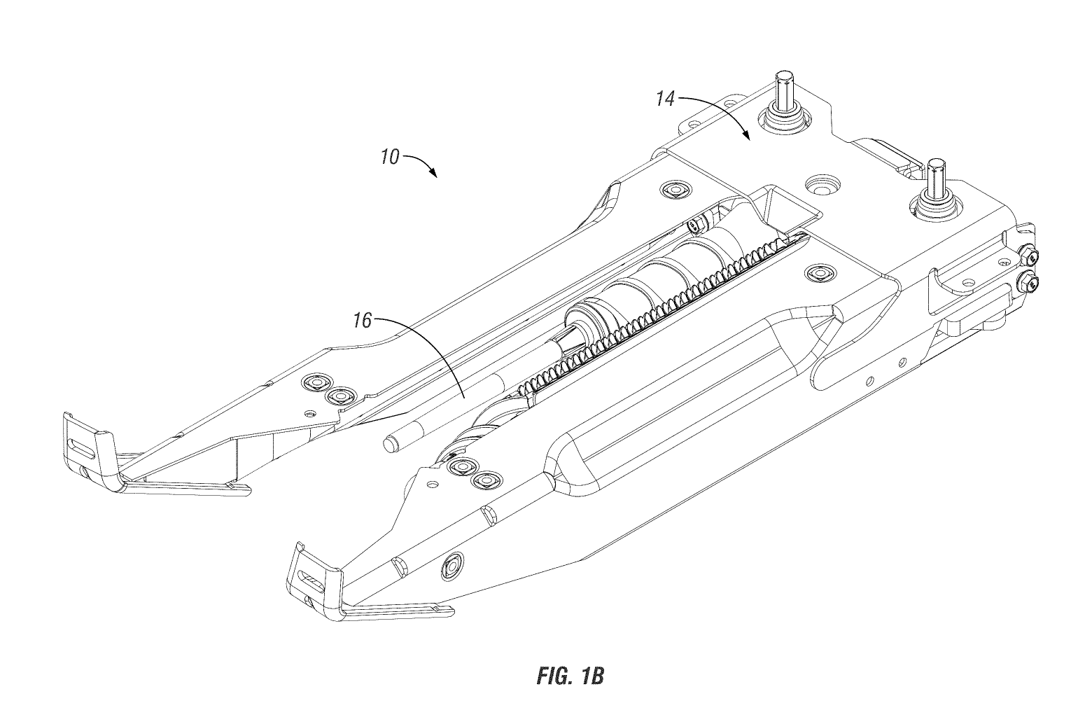

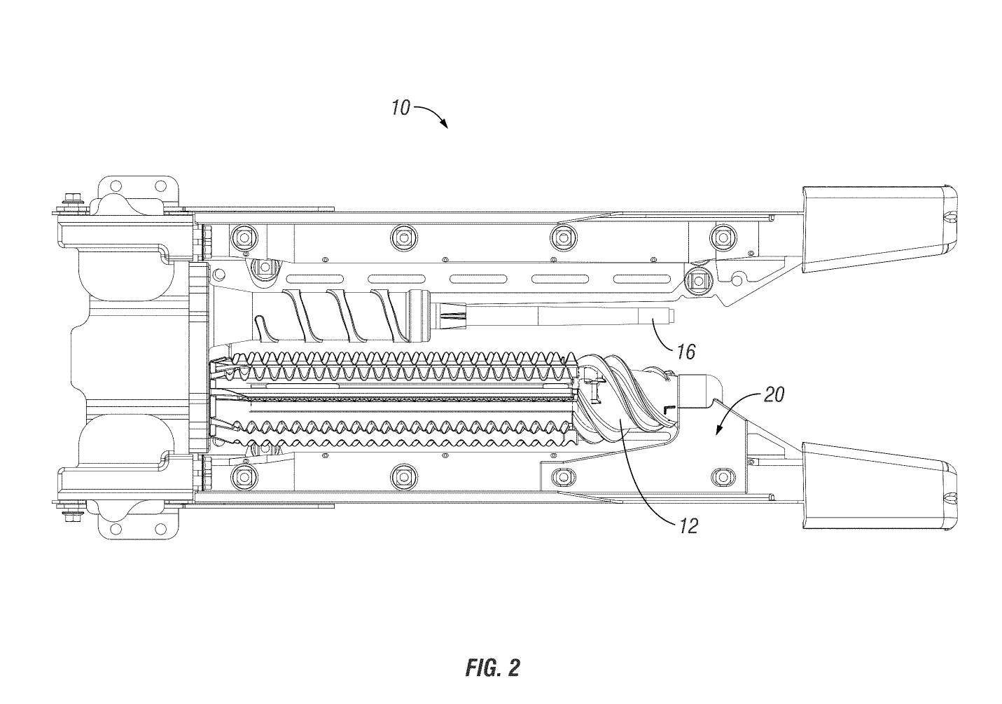

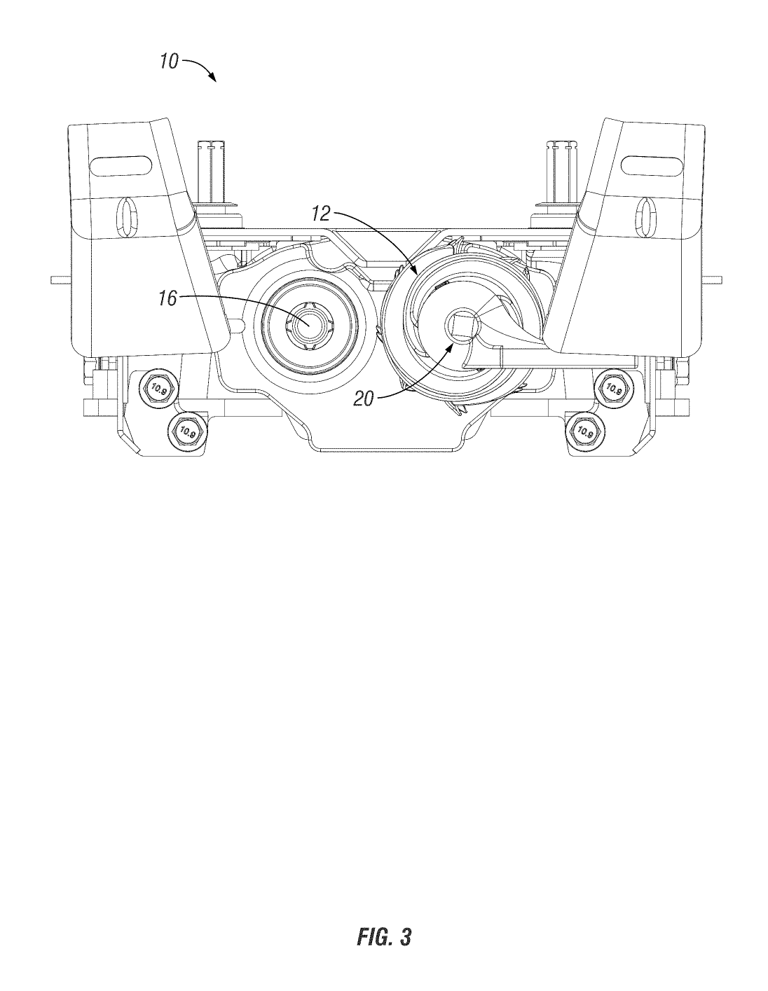

Referring to FIGS. 1-3, a general row unit 10 for an agricultural grain head is shown. The row unit 10 includes a stalk roller 12. A stalk roller 12 may be slidably attached to the stalk shaft 16, wherein the stalk shaft 16 is inserted into the stalk roller 12. A flange nut, pin, or similar fastening member may be used to secure the stalk roller 12 to the stalk roller shaft 16. The stalk roller may include a rounded or cone-shaped nose portion proximate the front of the row unit 10. The rear portion of the stalk roller 12 may include tines, splines, spikes, or the like configured to grip and pull the stalk. Generally there will be a pair of stalk rollers 12, one positioned on each side of the row unit 10. The tines, splines, spikes, etc. of the pair of stalk rollers 12 may be configured to operate in unison as the stalk rollers 12 are rotated. The stalk rollers 12 may be configured to pull the stalk in a generally downward direction as the stalk moves from the front tip of the row unit 10 toward the rear portion of the row unit 10, as part of the process of removing the ear of corn or other types of grain from the stalk. Current stalk rollers 12 may include a flattened portion proximate the nose or tip of the stalk roller 12. The nose or tip of the stalk roller 12 is also generally un-attached. As stalks are fed into the row unit 10, it is possible for debris and other particulate materials to become lodged in the nose of the stalk roller. Furthermore, the un-attached nose of the stalk roller 12 may become misaligned as a result of the forces and/or loading that is applied to the nose of the stalk roller. Various guide plates and “trash knives” have been developed to try and eliminate the build-up of debris at the nose of the stalk roller 12. However, present trash knife designs fail to protect the nose and/or balance and align the front tip of the stalk roller 12 as it is rotated.

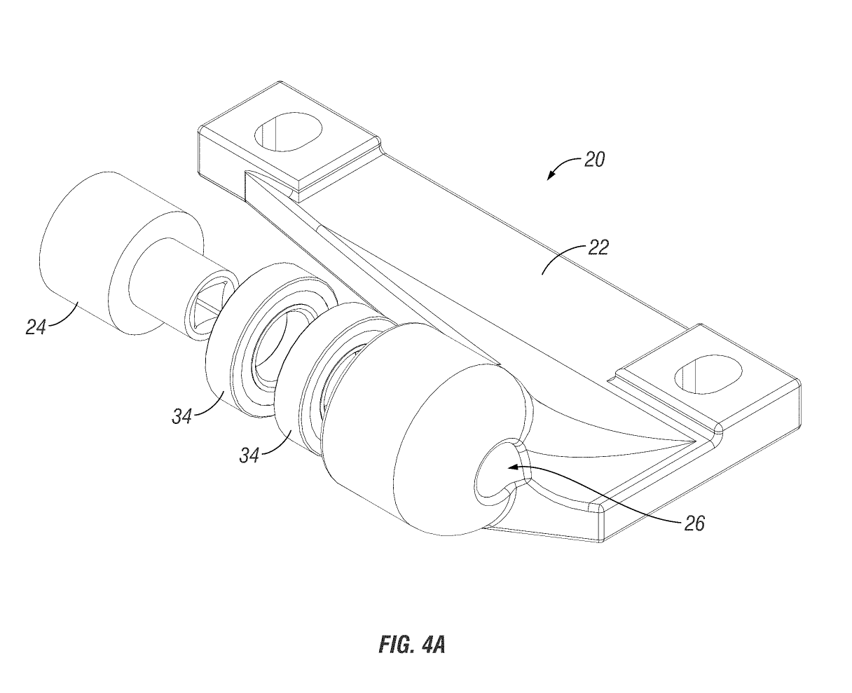

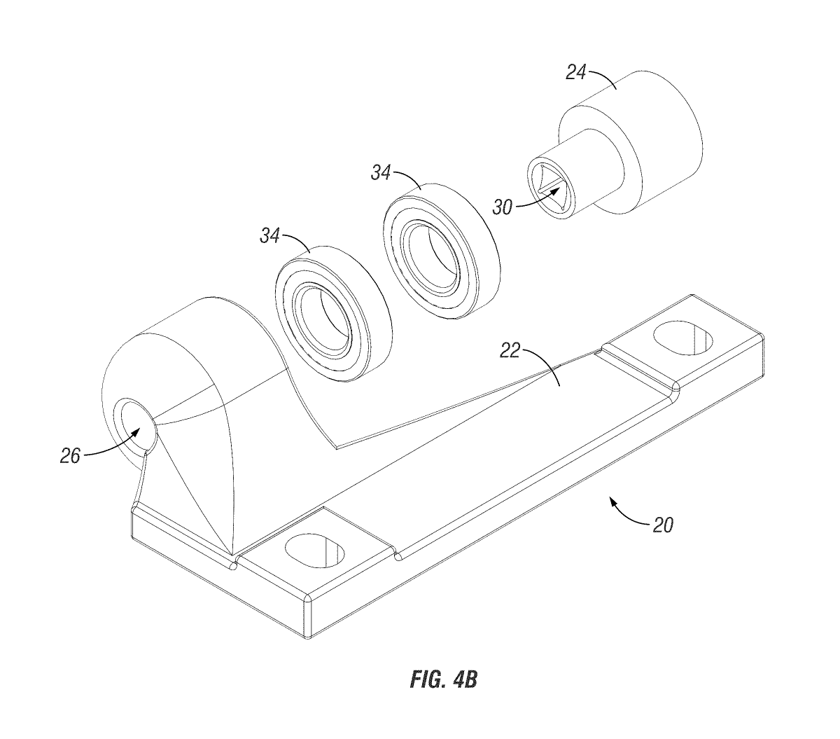

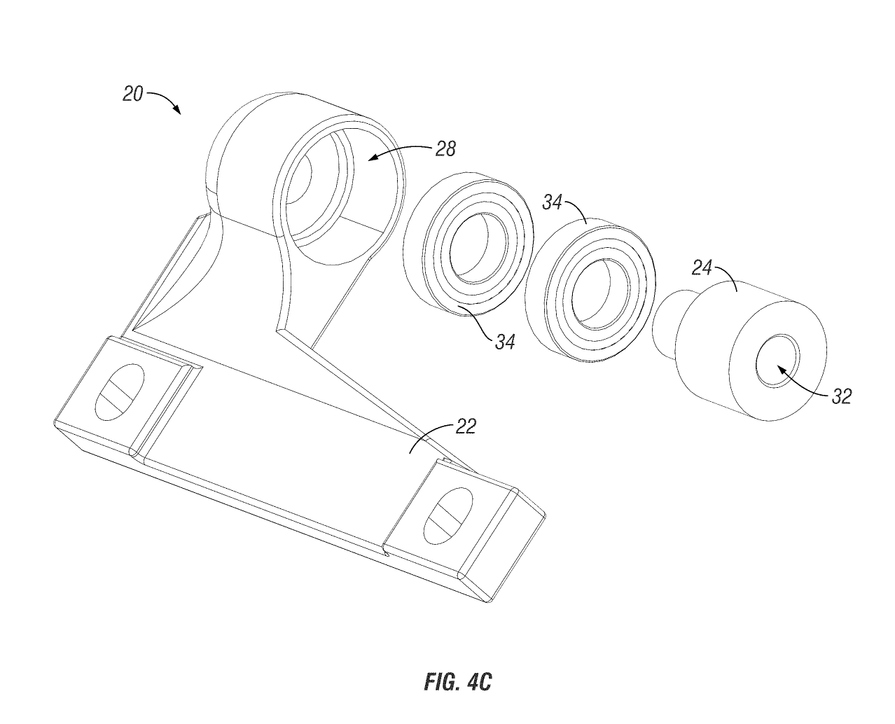

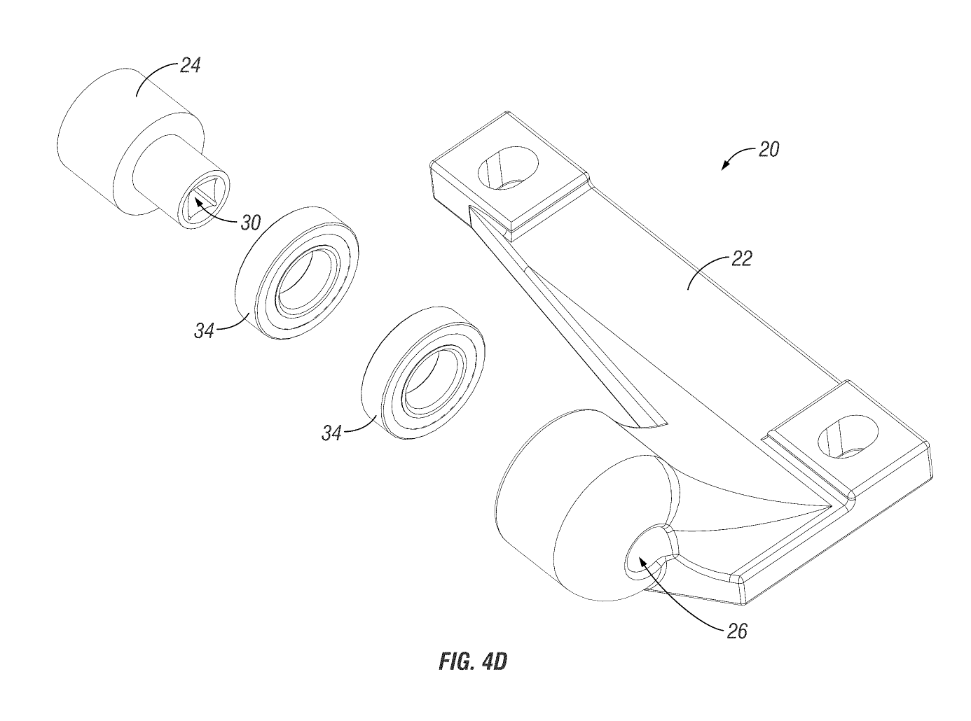

Referring to FIGS. 4A-4D, a stalk roller retention assembly 20 is shown. The stalk roller retention assembly 20 may include a stalk roller retention bracket 22 and a stalk roller coupler 24. The stalk roller retention bracket 22 may be configured to be removably affixed to the underside of the row unit frame. Holes or apertures in the bracket 22 may be positioned to correspond with the existing holes in the row unit frame for installation of prior trash knife models. The bracket 22 may be constructed of a metal alloy or another material having similar mechanical properties. The bracket may be machined or cast. The bracket 22 may also include a pocket or cavity 28 configured to slidably receive the stalk roller coupler 24.

The stalk roller coupler 24 may have a generally round profile and be configured fit within the cavity 28 of the bracket 22. The stalk roller coupler 24 should fit snugly, but the tolerances should allow for the coupler 24 to rotate within the cavity 28. The stalk roller coupler may also include a nose portion. The nose portion of the coupler 24 may have a smaller diameter than the primary outer diameter of the coupler 24. The nose portion may be configured to fit within the inner diameter of one or more roller bearings 34. The roller bearings 34 may have an outer diameter configured to be press fitted within the cavity 28 of the bracket 22. For example, one or more bearings 34 may be press fit within the cavity 28, then the nose of the coupler 24 may be slidably inserted into the aperture defined by the inner diameter of the bearing(s) 34. The bearing(s) 34 may transfer any load or forces experienced by the coupler 24 to the bracket 22, while still allowing the coupler 24 to freely rotate.

As discussed above, the stalk roller 12 may be secured to the stalk roller shaft 16 by a flange nut or a similar type fastener proximate to the nose or tip of the stalk roller 12. The rear portion of the coupler 24 may include an aperture with female threading 32 to match the male threading on the tip of the stalk roller shaft 16. The threaded portion 32 of the coupler 24 may allow the coupler 24 to secure the stalk roller 12 to the stalk roller shaft 16. For example, the stalk roller 12 may be slid over the stalk roller shaft 16 and the coupler 24 may be threaded onto the tip of the shaft 16 to secure the stalk roller 12 to the shaft 16. Furthermore, the nose of the coupler 24 may include an aperture 30 with a square or hex pattern to allow for the use of a ratchet wrench, hex key, Allen key or Allen wrench to tighten the coupler 24 onto the shaft 16. For example, the aperture 30 in the nose of the coupler 24 may be sized to fit a half-inch (½″) ratchet wrench. Alternatively, the nose portion may be solid and have a hexagonal shape or “hex shaft” design to allow the use of a socket or end-wrench to tighten the coupler 24 to the shaft 16. In the hex shaft embodiment, a bearing may not be required, but instead the hex shaft portion of the coupler 24 may be inserted into a casting/bearing assembly of the bracket 22 with a close slip fit and a hex shaft. Furthermore, a needle bearing may also be utilized in lieu of one or more roller bearings for a more compact design. Needle bearings have a large surface area that is in contact with the bearing outer surfaces compared to ball bearings. Additionally there is less added clearance (difference between the diameter of the shaft and the diameter of the bearing) so they are much more compact. The typical structure consists of a needle cage which orients and contains the needle rollers, the needle rollers themselves, and an outer race (sometimes the housing itself). Radial needle bearings are cylindrical and use rollers parallel to the axis of the shaft. Thrust needle bearings are flat and use a radial pattern of needles.

As shown in FIG. 4A, the nose of the cavity 28 portion of the bracket 22 may include an aperture 26. The aperture 26 may allow the user to access the nose portion of the coupler 24 to tighten the coupler 24 to the shaft 16 without removing the bracket 22 from the row unit 10. The aperture 26 may include internal or female threading to allow for a plug or cap to be removably inserted in the aperture 26. The cap or plug will prevent dirt, dust, or other debris from entering the cavity when the row unit 10 is operated.

The stalk roller shaft retention assembly 20 may be configured to be fully retro-fitted to all John Deere 600 series agricultural combine heads. When the stalk roller shaft retention assembly 20 is installed on the row unit 10, the free end of the stalk roller 12 and shaft 16 is supported by the bracket 22. This will reduce and generally eliminate any displacement or misalignment of the shaft 16 and/or roller 12. As a result, the loading on the row unit 10 gearbox and/or gear assembly is reduced, improving the lifetime of the gear box bearings and gear assembly. The roller/ball bearings 34 or needle bearings will maintain the alignment of the stalk roller 12 while allowing the roller 12 to spin freely and uninhibited. The assembly 20 will also transfer any loading or mechanical forces experienced proximate to the tip of the stalk roller 12 to the bracket 22. The combination of the coupler 24 that is secured to the stalk roller 12 and the cavity 28 of the bracket 22 will protect the nose of the stalk roller 12. Furthermore, the assembly 20 will prevent nesting and/or build-up of debris at the nose of the stalk roller 12 during operation. The assembly 20 may also be designed to allow for the installation of additional trash knives in combination with the assembly 20.

A stalk roller shaft retention assembly system including a coupler secured to a stalk roller and a bracket slidably attached to the coupler has thus been described. The present invention contemplates numerous variations, options and alternatives, and is not to be limited to the specific embodiments described herein. Other changes are considered to be part of the present invention.

What is claimed is:

1. A row unit for an agricultural corn head, said row unit comprising:
a row unit frame comprising a pair of frame members;
a gearbox coupled to the row unit frame, said gearbox comprises a gearing assembly with at least one rotatable shaft member;
a stalk shaft extending from the at least one rotatable shaft member of the gear box;
a stalk roller slidably attached to the stalk shaft, said stalk roller configured to encompass the stalk shaft;
wherein the stalk roller comprising a first end and a second end;
a stalk roller coupler removably attached to the stalk shaft proximate to the first end of the stalk roller; and
a stalk roller retention bracket slidably attached to the stalk roller coupler and removably secured to the row unit frame.

2. The row unit of claim 1, wherein the pair of frame members are oriented in parallel.

3. The row unit of claim 1, wherein the stalk roller retention bracket further comprises a cavity configured to slidably receive the stalk roller coupler.

4. The row unit of claim 3, further comprising one or more bearings positioned within the cavity of the stalk roller retention bracket, said one or more bearings are operatively attached to the stalk roller coupler.

5. The row unit of claim 3, wherein the stalk roller retention bracket further comprises an aperture proximate to the cavity.

6. The row unit of claim 5, further comprising a plug configured to removably fit within the aperture proximate the cavity.

7. The row unit of claim 1, wherein the stalk roller coupler comprises a nose portion and a rear portion.

8. The row unit of claim 7, wherein the rear portion of the stalk roller coupler further comprises a threaded portion configured to secure the rear portion of the stalk roller coupler to the first end of the stalk roller.

9. The row unit of claim 7, wherein the nose portion of the stalk roller coupler further comprises an aperture, said aperture configured in a polygonal shape.

10. The row unit of claim 9, wherein the aperture in the nose portion of the stalk roller coupler is configured to receive a half-inch ratchet drive to for attaching the stalk roller coupler to the first end of the stalk roller.

11. The row unit of claim 1, wherein the row unit comprises a pair of stalk rollers oriented in parallel.

12. The row unit of claim 1, wherein the stalk shaft further comprises a threaded portion proximate to a tip of the stalk shaft.

13. The row unit of claim 13, wherein the tip portion of the stalk shaft is opposite the gear box.

14. A stalk roller assembly comprising:
a stalk roller comprising a first end and a second end, said stalk roller configured to encompass a stalk shaft;
a stalk roller coupler removably attached to the stalk shaft proximate to the first end of the stalk roller; and
a stalk roller retention bracket slidably attached to the stalk roller coupler.

15. The stalk roller assembly of claim 14, wherein the stalk roller retention bracket further comprises a cavity configured to slidably receive the stalk roller coupler.

16. The stalk roller assembly of claim 15, further comprising one or more bearings positioned within the cavity of the stalk roller retention bracket, said one or more bearings are operatively attached to the stalk roller coupler.

17. A stalk roller retention assembly comprising:
a stalk roller retention bracket including a cavity;
a stalk roller coupler configured to be inserted within the cavity of the stalk roller retention bracket;
said cavity comprising an aperture; and
a plug removably inserted within the aperture.

18. The stalk roller retention assembly of claim 17, wherein the aperture further comprises internal threads.

19. The stalk roller retention assembly of claim 18, wherein plug further comprises external threads configured to matingly contact the internal threads of the aperture.
